(19) United States
(12) Patent Application Publication
(10) Pub. No.: US 2011/0157426 A1
(43) Pub. Date: Jun. 30, 2011

(54) VIDEO PROCESSING APPARATUS AND VIDEO PROCESSING METHOD THEREOF

(75) Inventors: Po-Jung Lin, Kaohsiung City (TW); Shuei-Lin Chen, Kaohsiung City (TW)

(73) Assignee: ALTEK CORPORATION, Hsinchu (TW)

(21) Appl. No.: 12/649,871

(22) Filed: Dec. 30, 2009

(51) Int. Cl. H04N 5/262; H04N 5/228

(52) U.S. Cl. 348/239; 348/222.1; 348/E05.055

(57) ABSTRACT

A video processing apparatus and a video processing method are used to capture a view region as a video result. The video processing apparatus includes a video sensor, a temporary memory, and a video pipeline. The video sensor captures the view region at a sensor frame rate and generates a video having a plurality of frames. The video pipeline receives one of the frames directly from the video sensor to serve as a first frame. The video pipeline processes the first frame to generate a temporary result frame, and then generates a video result at a video frame rate according to the temporary result frame and a second frame directly received from the video sensor, wherein the video frame rate is smaller than the sensor frame rate. The video processing method captures the view region as the video result by using the video processing apparatus.

### BACKGROUND OF THE INVENTION

1. Field of Invention

The present invention relates to a video processing apparatus and a video processing method thereof, and more particularly to a video processing apparatus and a video processing method thereof that are capable of saving capacity of a required memory and bandwidth.

2. Related Art

Users can capture images or videos by using image/video capture apparatuses such as digital cameras or video cameras, and obtain image/video output files which can be played. However, the data initially obtained by the apparatuses such as digital cameras by an image sensor is raw data, which cannot be provided for users to watch until it is processed by many procedures.

Most of current digital image processing (DIP) techniques employ a pipeline system to process image/video raw data. The pipeline system can perform a series of processes on a single image. The pipeline system usually has a plurality of processing stages, and can continuously process input images step by step with methods such as applying filters. For example, the pipeline system can use filters to convert input images/videos into an RGB color space model, and can also convert an original file into a universal image format.

However, since a sensor frame rate used by a conventional image sensor is substantially equal to a video frame rate when a video is output, the video processing must be finished in one frame time. Thus, requirements on the hardware speed and the memory of the pipeline system are virtually restricted. Especially, at present, the quite popular multi-scale or multi-frame image application technique further increases the hardware cost required by the pipeline system.

The multi-scale or multi-frame processing technique must process multiple input frames to generate one output frame. For example, a source image provided by the image sensor is processed like continuous frames, the previous frame is firstly stored in an input buffer, and when the next frame is being processed, the previous frame must be read from the input buffer to be processed together. Therefore, the pipeline system requires at least one additional input buffer, thereby keeping the frames provided by the image sensor to facilitate subsequent processing, which is a great challenge for capacity of a memory and bandwidth.

Furthermore, along with the advancement of technology, the resolution of an image or video is also increased. This also represents that the input buffer should have a larger capacity. In other words, the input buffer needs a higher cost, and the bandwidth necessary for reading or writing source images from on into the memory becomes higher with the addition of processing stages. Furthermore, a large amount of access computation need be preformed to process multi-frame images, which even cause a problem of frame delay to the conventional video processing method.

### SUMMARY OF THE INVENTION

In order to solve the aforementioned problems of the pipeline system including a higher cost and frame delay, the present invention provides a video processing apparatus and a video processing method thereof, which are used to capture a view region as a video result. The video processing apparatus and the video processing method of the present invention are free of requirements for the input buffer, so as to reduce the required hardware cost, solve the problem of frame delay, and reduce the reading and writing bandwidth required by a memory.

The video processing apparatus comprises a video sensor, a temporary memory, and a video pipeline. The video sensor captures the view region at a sensor frame rate and generates a video having a plurality of continuous frames. The video pipeline receives one of the frames directly from the video sensor to serve as a first frame. The video pipeline processes the first frame to generate a temporary result frame, and then generates the video result at a video frame rate according to the temporary result frame and a second frame directly received from the video sensor. The second frame is the frame next to the first frame, and the video frame rate is smaller than the sensor frame rate.

According to an embodiment of the present invention, the video pipeline is selected from a group consisting of an image processing unit, an image scaling unit, an image blending unit, a frame rate conversion unit, and an image compression unit, or a combination thereof.

According to another embodiment of the present invention, the image blending unit of the video pipeline generates the video result according to the temporary result frame and the second frame. Preferably, the video processing apparatus further comprises a result memory, and the video pipeline stores the video result in the result memory.

The present invention provides a video processing method, which comprises capturing a view region and generating a video comprising a plurality of continuous frames; directly receiving one of the frames to serve as a first frame, and processing the first frame to generate a temporary result frame; directly receiving a second frame, in which the second frame is a frame next to the first frame; and generating a video result according to the second frame and the temporary result frame.

Preferably, in the video processing method, the video pipeline receives one of the frames to serve as the first frame, and processes the first frame to generate the temporary result frame. The step of generating the video result according to the second frame and the temporary result frame comprises processing the second frame and the temporary result frame by an image blending unit of the video pipeline, so as to generate the video result.

Furthermore, the video processing method further comprises storing the temporary result frame in a temporary memory. The video processing method also comprises storing the video result in the result memory. The video pipeline can process the rest of the directly received frames as the first frame and the second frame alternately till all the frames are processed.

In view of the above, the video processing apparatus and the video processing method thereof according to the present invention can obtain images by using the video sensor having the higher sensor frame rate, and then makes the video sensor directly transmit (the plurality of frames of) the image to the video pipeline. Therefore, the video pipeline can directly obtain necessary frames to process without requiring any input buffer. Therefore, according to the processing method, the video processing apparatus can perform the multi-scale or multi-frame image processing technique without configuring any input buffer, thereby effectively reducing the capacity of the whole memory and the reading and writing bandwidth required by the memory.

### BRIEF DESCRIPTION OF THE DRAWINGS

The present invention will become more fully understood from the detailed description given herein below for illustration only, and thus are not limitative of the present invention, and wherein:

FIG. 1A is a schematic block diagram of a video processing apparatus according to an embodiment of the present invention;

FIG. 1B is a schematic block diagram of a video processing apparatus according to another embodiment of the present invention;

FIG. 2 is a block diagram of processes of a video processing apparatus according to an embodiment of the present invention;

FIG. 3 is a schematic view of processes of a video processing method according to another embodiment of the present invention;

FIG. 4 is a block diagram of processes of a multi-scale application example according to the present invention; and

FIG. 5 is a block diagram of processes of a multi-frame application example according to the present invention.

### DETAILED DESCRIPTION OF THE INVENTION

The detailed features and advantages of the present invention will be described in detail below in the embodiments. Those skilled in the arts can easily understand and implement the content of the present invention. Furthermore, the relative objectives and advantages of the present invention are apparent to those skilled in the arts with reference to the content disclosed in the specification, claims, and drawings.

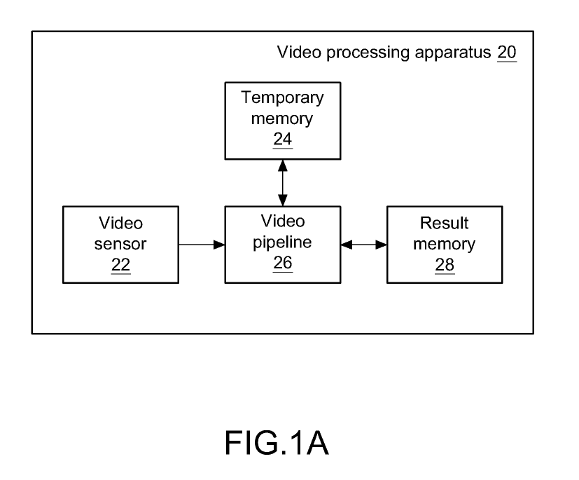

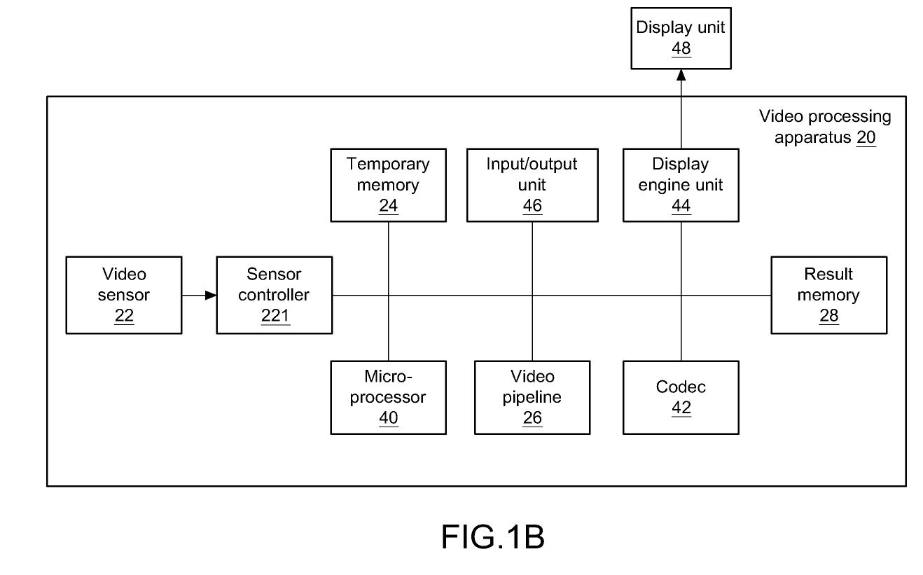

A video processing apparatus and a video processing method thereof in the present invention are used to capture a view region as a video result. FIG. 1A is a schematic block diagram of a video processing apparatus according to an embodiment of the present invention. Referring to FIG. 1A, the video processing apparatus 20 comprises a video sensor 22, a temporary memory 24, a video pipeline 26, and a result memory 28. The video processing apparatus 20 obtains raw data of a video according to a view region through the video sensor 22, and then processes the video as the video result by the video pipeline 26.

The video sensor 22 is also referred to as an image sensor, for example, an image capture unit or an image photo-sensitive element of apparatuses such as a digital camera, a mobile phone, and a video camera. For example, the video sensor 22 can be a charge coupled device (CCD), or can also be a complementary metal-oxide-semiconductor (CMOS) photo-sensitive element. More specifically, when the user captures the video for an ambient scene with the digital camera, the video sensor 22 captures the reflective light of a scene entering the digital camera through a lens as the video. The view region is the scene that can be captured by the CCD or CMOS of the digital camera.

The video captured by the video sensor 22 can comprise a plurality of continuous frames, and can also comprise audio. Furthermore, the video sensor 22 captures images for the view region at a high sensor frame rate. The sensor frame rate can be, for example, 60 frames per second or 90 frames per second. With the advancement of technology, the sensor frame rate of the video sensor 22 can even reach 120 frames per second in future. It should be noted that, the sensor frame rate of the video sensor 22 need be larger than a video frame rate in outputting the video result. Preferably, the sensor frame rate is at least twice of the video frame rate.

Furthermore, the video processing apparatus 20 and the video processing method thereof in the present invention are mainly directed to processing of the frames of a video, and the method of processing an audio is not limited.

The video pipeline 26 sequentially receives the frames captured by the video sensor 22 in a time axis, and performs various types of digital image processing (DIP) on the received frames, so as to obtain the video result.

According to an embodiment of the present invention, the video result refers to the frames processed by the video pipeline 26, and the processed frames can be synthesized into an output video. According to another embodiment of the present invention, the video processing apparatus 20 can receive frames and only generate the video result as the output, and at this time, the output is a still image. Although the specification mainly describes outputting a video as an example, the video processing apparatus and the video processing method thereof in the present invention can also be used to process a still image.

The video pipeline 26 can comprises various different processing units according to the functions. Basically, the video pipeline 26 at least comprises an image processing unit. Besides the image processing unit, the video pipeline 26 can also comprise processing units such as an image scaling unit, an image blending unit, a frame rate conversion unit, and an image compression unit.

The processing units will be introduced in brief as follow.

The image scaling unit is used for downsizing (or down-scaling) or upsizing (or up-scaling) the frames. When the user has low requirements on the resolution of the video result, the video processing apparatus 20 can use the image scaling unit to reduce the resolution of the video, so as to save the space required for storing the video result. Furthermore, for example, when digital image processing such as super resolution is performed, the image scaling unit is also necessary. Moreover, for example, the image scaling unit can process an image (or a frame) into different resolutions, so as to obtain features of the image in different resolutions.

The image blending unit is used to blend frames (two in most cases) into a new frame. The image blending unit can calculate the RGB color or brightness of the new frame according to the RGB color or brightness of each pixel in the blended frames, thereby obtaining different blending effects.

The frame rate conversion unit is used to increase or decrease the video frame rate of an output video in a specific range. The frame rate conversion unit reduces the number of video results contained in the output video, so as to reduce the video frame rate, and can also generate a tweening frame by interpolation and add it to the output video to enhance the video frame rate. The frame rate conversion unit can also be controlled by software without any additional hardware unit.

The image compression unit can employ lossy compression, that is, reduce the quality of the frame to reduce the storage space occupied by the video results. The image compression unit is also used to compress the output video in different video formats, such as the MPEG-2 format established by the Moving Picture Experts Group (MPEG) or the Blu-ray format emphasizing the frame quality.

The image processing unit can perform multiple processes on the image, such as sharpening, color correction or redeye removal, automatic white balance, and tone processing. The filters and calculation methods used by the image processing unit can be varied depending on the required different functions, and are not limited in the present invention. The image processing unit can also use filters to remove salt and pepper noises or high ISO noises in the frame, so as to obtain a better frame quality. For example, a simple filter can be a median filter or a linear filter.

FIG. 1B is a schematic block diagram of a video processing apparatus according to another embodiment of the present invention. Referring to FIG. 1B, in addition to the video sensor 22, the temporary memory 24, the video pipeline 26, and the result memory 28, the video processing apparatus 20 further comprises a sensor controller 221, a microprocessor 40, a codec 42, a display engine unit 44, and an input/output unit 46.

The sensor controller 221 is used to generate a high-speed control signal to control the video sensor 22.

The microprocessor 40 controls the whole operation of the video processing apparatus 20, for example, sends various commands to make the video pipeline 26 to cooperatively process the image captured by the video sensor 22.

The codec 42 is used to encode or compress the image, for example, convert the image into an audio video interleave (AVI) format or a moving picture experts group (MPEG) format.

The display engine unit 44 is used to display the image captured by the video sensor 22 or the image read from an external storage on a display unit 48 connected to the video processing apparatus 20. The display unit 48 outputs the video according to the video frame rate, and the video frame rate is lower than the sensor frame rate. Preferably, the sensor frame rate is at least twice of the video frame rate. Furthermore, the display unit 48 is mounted on the video processing apparatus 20, such as a liquid crystal display (LCD), or is externally connected to the video processing apparatus 20, such as a TV screen.

The video processing apparatus 20 can also comprise an input/output unit 46, for example, an external memory card control unit, for storing the processed video data in a memory card. The memory card can be, for example, a secured digital card (SD card), a memory stick memory card (MS card), or a compact flash memory card (CF card).

By the video pipeline 26 having the aforementioned processing units, the frames of the video captured by the video sensor 22 are converted into the video results, and the multiple video results are combined into an output video. In the period when the video pipeline 26 processes the frames, some processed frames can also be used as a temporary result frame, and the temporary result frame is stored in the temporary memory 24. According to an embodiment of the present invention, the temporary memory 24 is configured in the video pipeline 26. That is to say, the temporary memory 24 can be an internal storage or an L2 cache in the video pipeline 26.

More specifically, the video pipeline 26 directly receives one of the frames captured by the video sensor 22 to serve as a first frame, processes the first frame to generate the temporary result frame, and stores the temporary result frame in the temporary memory 24. Next, the video pipeline 26 directly receives the frame next to the first frame from the video sensor 22 as a second frame, and generates the video result according to the temporary result frame and the second frame.

According to an embodiment of the present invention, the video pipeline 26 stores the processed video result (and the output video) in the result memory 28, and the result memory 28 can be an external storage of the video pipeline 26. According to another embodiment of the present invention, the temporary memory 24 and the result memory 28 can be the same memory, and distinguished by memory addresses. In other words, the temporary memory 24 and the result memory 28 can be storage spaces of different addresses in the same memory.

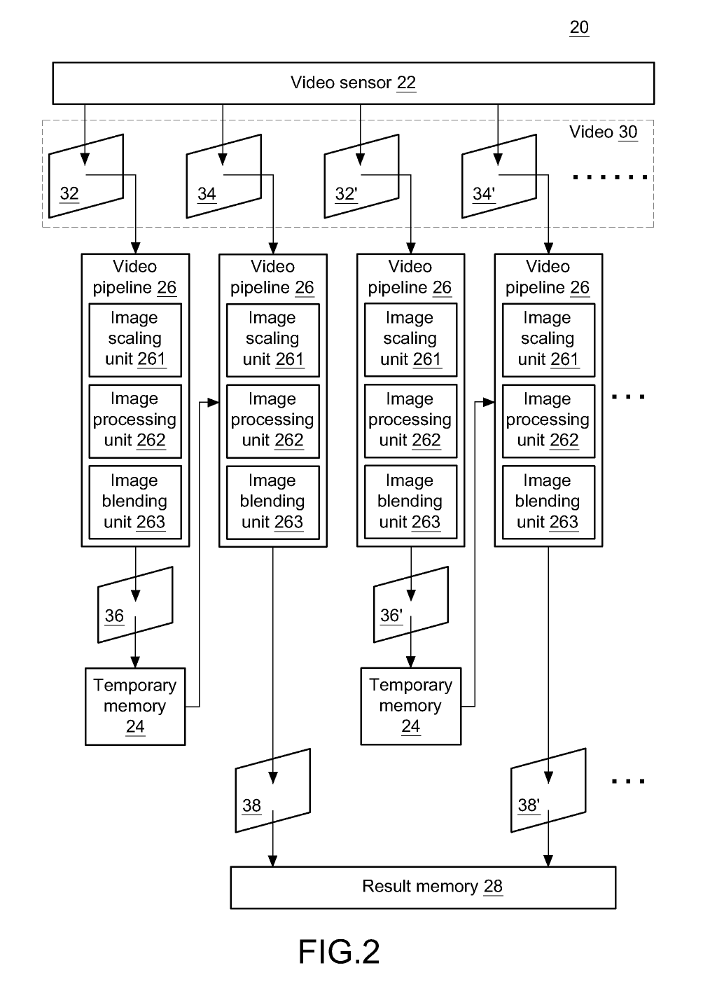

Referring to FIGS. 1A, 1B, and 2, FIG. 2 is a block diagram of processes of a video processing apparatus according to an embodiment of the present invention. In this embodiment, the sensor frame rate of the video sensor 22 is twice of the video frame rate of outputting the output video. As shown in FIG. 2, the video sensor 22, according to the sensed frame, captures the view region to generate a video 30, and the video 30 has the plurality of frames. The video pipeline 26 comprises an image scaling unit 261, an image processing unit 262, and an image blending unit 263.

The video pipeline 26 directly receives one of the frames from the video sensor 22 to serve as the first frame 32, processes the first frame 32 to generate the temporary result frame 36, and stores the temporary result frame 36 in the temporary memory 24.

Next, the video pipeline 26 receives and processes the second frame 34, and blends the processed second frame 34 and the temporary result frame 36 read from the temporary memory 24 into the video result 38 by using the image blending unit 263. Afterwards, the video result 38 can be stored in the result memory 28.

As time elapses, the video pipeline 26 receives the first frame 32′ again to generate the temporary result frame 36′, and blends the second frame 34′ and the temporary result frame 36′ by the image blending unit 263 to generate the video result 38′. The video pipeline 26 repeats the steps of receiving and processing the frames till all the frames transmitted by the video sensor 22 are processed, so as to obtain the video result 38 corresponding to the video 30.

Moreover, the video result 38 can be decoded by the codec 42, and displayed on the display unit 48 through the display engine unit 44. The display unit 48 outputs the video result 38 at the video frame rate lower than the sensor frame rate. For example, when the sensor frame rate used by the video sensor 22 is 60 frames per second, the display unit 48 outputs the video result 38 at the video frame rate of 30 frames per second.

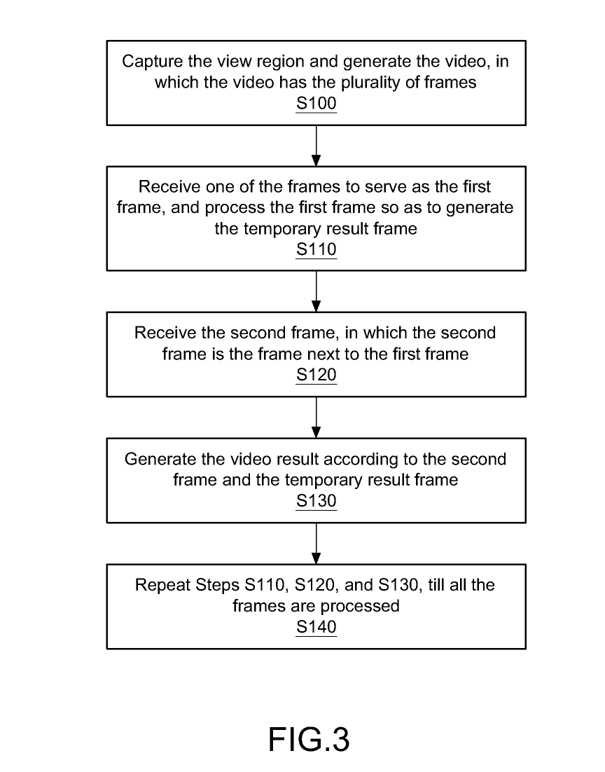

FIG. 3 is a schematic view of processes of a video processing method according to another embodiment of the present invention. Referring to FIG. 3, it can be known that, the video processing method comprises the following steps. In Step S100, the view region is captured and the video is generated, in which the video has the plurality of frames. In Step S110, one of the frames is received as the first frame, and the first frame is processed to generate the temporary result frame. In Step S120, the second frame is received, and the second frame is the frame next to the first frame. In Step S130, the video result is generated according to the second frame and the temporary result frame. In Step S140, Steps S110, S120, and S130 are repeated till all the frames are processed.

The Step S110 is performed by the video pipeline 26, and the Step S130 is performed by the image blending unit 263. Preferably, after the temporary result frame 36 is obtained in the Step S110, the video processing method further comprises storing the temporary result frame 36 in the temporary memory 24. Additionally, after the video result 38 is obtained in the Step S130, the video processing method further comprises storing the video result 38 in the result memory 28.

It should be noted that, the first frame 32 and the second frame 34 are directly received from the video sensor 22 by the video pipeline 26.

Steps S100-S130 are steps of the video processing method for generating the video result 38. In Step S140, the video processing method can repeat these steps till all the frames of the video 30 are processed, and the output video containing all the video results 38 is obtained. That is to say, the video pipeline 26 can process the rest of the directly received frames as the first frame 32 and the second frame 34 alternately till all the frames of the video 30 are processed.

More specifically, the video pipeline 26 processes the rest of the frames of the video 30 sequentially and alternately as the first frame 32 and the second frame 34, and the video pipeline 26 processes the first frame 32 to generate the temporary result frame 36. The video pipeline 26 then generates the video result 38 according to the temporary result frame 36 and the second frame 34 directly received from the video sensor 22. The video pipeline 26 outputs the video result 38 at the video frame rate smaller than the sensor frame rate, till the frames of the video 30 are processed.

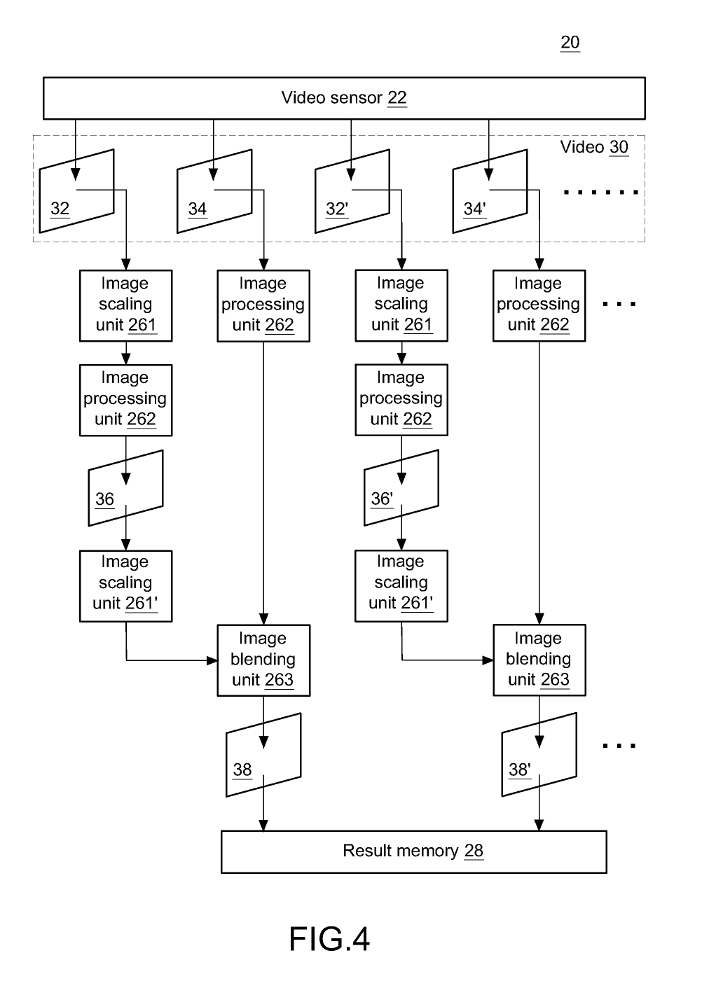

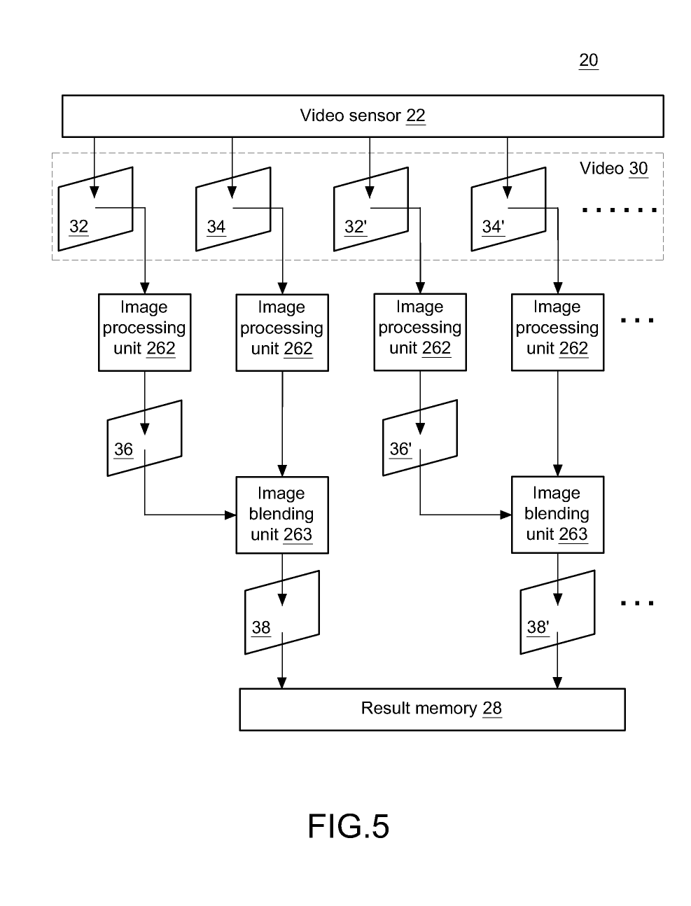

FIGS. 4 and 5 are the block diagrams of processes of the examples of the multi-scale application and the multi-frame application according to the present invention. Referring to FIGS. 4 and 5, the embodiments in FIGS. 4 and 5 are respectively a multi-scale application example and a multi-frame application example using the practice of the video processing apparatus 20 of the present invention.

In the embodiment of FIG. 4, the video sensor 22 provides the first frame 32 and the second frame 34 to the video pipeline 26, and the video pipeline 26 generates the video result 38 after the two stages of processing. In this embodiment, the sensor frame rate of the video sensor 22 is twice of the video frame rate necessary for outputting, and the video pipeline 26 comprises an image scaling unit 261, an image scaling unit 261′, an image processing unit 262, and an image blending unit 263. The image scaling unit 261 serves as a first image scaling unit, and the image scaling unit 261′ serves as a second image scaling unit. The pair of image scaling units both has the functions of upsizing or downsizing an image, and when one of them is used to upsize an image, the other is used to downsize an image.

In the first stage of processing, the video pipeline 26 can use the image scaling unit 261 to downsize the first frame 32 firstly, and the image processing unit 262 extracts an image feature of the downsized first frame 32. The image feature can be, for example, an edge of the first frame 32 obtained by an edge-detection method, or a low frequency part of the first frame 32 processed by a low pass filter. The image feature is stored in the temporary memory 24 as the temporary result frame 36. Next, in the second stage of processing, the video pipeline 26 restores the size of the downsized first frame 32 to the original resolution by using the image scaling unit 261′ before doing image blending. Besides, in the second stage of processing, the video pipeline 26 receives the second frame 34 and processes the second frame 34 by using the image processing unit 262. The image scaling unit 261′ reads out the temporary result frame 36 from the temporary memory 24, restores the size of the temporary result frame 36 from changed size to the original size, and transmits the image feature with the original size to the image blending unit 263. Finally, the image blending unit 263 blends the processed second frame 34 and the image feature with original size into the video result 38.

In a similar way, the rest of the frames are repeatedly processed according to the aforementioned method and will not be described any more.

According to another embodiment of the present invention, the video pipeline 26 can also select a part of the image feature, and only upsizes the image feature to the original resolution, so as to be blended with the processed second frame 34 to obtain the video result 38 by the image blending unit 263.

More specifically, the image feature has an original size (i.e., the original resolution of the first frame 32 and the image feature). In the first stage, the image scaling unit 261 serves as the first image scaling unit to change the size of the first frame 32. Next, the image processing unit 262 selects the image feature from the first frame 32 to serve as the temporary result frame 36 with the changed size. In the second stage of processing, The image scaling unit 261′ serves as the second image scaling unit to reads out the temporary result frame 36 from the temporary memory 24, restores the size of the temporary result frame 36 from changed size to the original size, and transmits the image feature with the original size to the image blending unit 263. Finally, the image blending unit 263 blends the processed second frame 34 and the image feature with original size into the video result 38.

In a similar way, the rest of the frames are repeatedly processed according to the aforementioned method and will not be described any more.

When the image scaling unit 261 downsizes an image, the image scaling unit 261′ upsizes an image, and on the contrary, when the image scaling unit 261 upsizes an image, the image scaling unit 261′ downsizes an image.

In the aforementioned embodiments, the image scaling units 261 and 261′ cooperate with each other. However, since the image scaling unit 261 has the functions of upsizing and downsizing an image, only the image scaling unit 261 can also be used to achieve the aforementioned purposes according to the demand. For example, if the current video pipeline 26 only has an image scaling unit 261, the image scaling unit 261 receives the first frame 32 and changes the size thereof. Then, the image processing unit 262 selects the image feature from the first frame 32 with the changed size to serve as the temporary result frame 36. The image scaling unit 261 also restores the size of the image feature to the original size, and transmits the image feature to the image blending unit 263.

In comparison, the conventional multi-scale application method should store the frame captured by the image sensor in an additional input buffer, so that the pipeline can perform the first and second stages of processing by the frames in the input buffer. Since the video sensor 22 of the video processing apparatus 20 in the present invention has the higher sensor frame rate, the video sensor 22 can continuously provide the first frame 32 and the second frame 34 in real time. Compared with the conventional method, the video processing apparatus 20 in the present invention need not the support from any input buffer.

In the multi-frame application example in FIG. 5, the sensor frame rate of the video sensor 22 is twice of the video frame rate necessary for outputting. For example, the first frame 32 is captured by the lens of the digital camera with an exposure duration of 1/45 seconds, and the second frame 34 is captured by the lens with an exposure duration of 1/90 seconds. The processed video result 38 can be an image having the exposure duration of 1/30 seconds, and the quality of the video result 38 is better than the frame captured directly with the exposure duration of 1/30 seconds. For example, the video result 38 has less noise or has a more distinct contrast than the frame captured with the exposure duration of 1/30 seconds.

Similar to the embodiment in FIG. 4, since the video sensor 22 has the higher sensor frame rate, the video processing apparatus 20 does not need the conventional input buffer and the bandwidth for writing into and reading from the input buffer. Furthermore, after the input buffer is removed, the problem of frame delay caused by the input buffer also disappears.

Furthermore, the first frame 32 and the second frame 34 are different images, that is to say, the first frame 32 and the second frame 34 can have different image information, so the video pipeline 26 can obtain more image information, so as to generate the preferable video result.

The video processing apparatus and the video processing method thereof in the present invention can be applicable to various digital image processing techniques, such as video text detection, sport event detection, blocking-artifact reduction, motion detection/compensation super resolution, blur deconvolution, face recognition, or video stabilization (vibration compensation).

In view of the above, the video processing apparatus and the video processing method thereof in the present invention can utilize the video sensor having the higher sensor frame rate to obtain an image, and then the video sensor directly transmits (the plurality of frames) of an image to the video pipeline. The video pipeline directly obtains the plurality of desired frames as input and processes them without obtaining the same frames as input from an input buffer, thereby efficiently reducing the capacity of the whole memory and reducing the bandwidth for writing and reading an image into and from the memory. Therefore, according to the processing method, the video processing apparatus can perform the multi-scale or multi-frame image processing techniques without configuring an input buffer. That is to say, the video processing apparatus and the video processing method thereof in the present invention can solve the problems of a high cost and frame delay due to an input buffer required by the conventional pipeline system.

What is claimed is:

1. A video processing apparatus, comprising:
a video sensor, for capturing a view region at a sensor frame rate and generating a video, wherein the video comprises a plurality of frames; and
a video pipeline, for directly receiving one of the frames from the video sensor to serve as a first frame, processing the first frame to generate a temporary result frame, generating a video result according to the temporary result frame and a second frame directly received from the video sensor, and outputting the video result at a video frame rate smaller than the sensor frame rate, wherein the second frame is the frame next to the first frame.

2. The video processing apparatus according to claim 1, wherein the video pipeline processes the rest of the frames sequentially and alternately as the first frame and the second frame, the video pipeline processes the first frame to generate the temporary result frame, generates the video result according to the temporary result frame and the second frame directly received from the video sensor, and outputs the video result at the video frame rate smaller than the sensor frame rate, till the frames are processed.

3. The video processing apparatus according to claim 1, further comprising:
a temporary memory, wherein the video pipeline stores the temporary result frame in the temporary memory.

4. The video processing apparatus according to claim 1, further comprising:
a result memory, wherein the video pipeline stores the video result in the result memory.

5. The video processing apparatus according to claim 1, wherein the video pipeline comprises:
an image blending unit, for blending the temporary result frame and the second frame to generate the video result.

6. The video processing apparatus according to claim 5, wherein the first frame has at least one image feature, the image feature has an original size, and the video pipeline further comprises:
a first image scaling unit, for receiving the first frame and changing a size of the first frame; and
an image processing unit, for selecting the image feature from the first frame with the changed size as the temporary result frame; the first image scaling unit restores the size of the temporary result frame to the original size, and transmits the image feature with the original size to the image blending unit, then the image blending unit blends the image feature with the original size with the second frame to generate the video result.

7. The video processing apparatus according to claim 5, wherein the first frame has at least one image feature, the image feature has an original size, and the video pipeline further comprises:
a first image scaling unit, for receiving the first frame and changing a size of the first frame;
an image processing unit, for selecting the image feature from the first frame with the changed size as the temporary result frame; and
a second image scaling unit, for restoring the size of the temporary result frame to the original size; then the image blending unit blends the image feature with the original size with the second frame to generate the video result.

8. The video processing apparatus according to claim 1, wherein an exposure duration of the first frame is different from the exposure duration of the second frame.

9. The video processing apparatus according to claim 1, wherein the video pipeline is selected from a group consisting of an image processing unit, an image scaling unit, an image blending unit, a frame rate conversion unit, and an image compression unit, or a combination thereof.

10. A video processing method, for capturing a view region as a video result, comprising:
capturing the view region at a sensor frame rate and generating a video, wherein the video comprises a plurality of frames;
(a) directly receiving one of the frames to serve as a first frame, and processing the first frame, so as to generate a temporary result frame;
(b) directly receiving a second frame, wherein the second frame is the frame next to the first frame; and
(c) generating the video result according to the second frame and the temporary result frame, and outputting the video result at a video frame rate smaller than the sensor frame rate, wherein the video frame rate is smaller than the sensor frame rate.

11. The video processing method according to claim 10, further comprising:
processing the rest of the frames as the first frame and the second frame alternately; and
repeating steps (a), (b), and (c), till the rest of the frames are processed.

12. The video processing method according to claim 10, wherein the step (a) is performed by a video pipeline.

13. The video processing method according to claim 12, wherein the video pipeline is selected from a group consisting of an image processing unit, an image scaling unit, an image blending unit, a frame rate conversion unit, and an image compression unit, or a combination thereof.

14. The video processing method according to claim 12, wherein the step (c) comprises:
processing the second frame and the temporary result frame by an image blending unit of the video pipeline, so as to generate the video result.

15. The video processing method according to claim 14, wherein the step (a) comprises:
changing a size of the first frame by a first image scaling unit of the video pipeline; and
selecting an image feature of the first frame as the temporary result frame from the first frame with the changed size by an image processing unit of the video pipeline;
and the step (c) comprises:
restoring the size of the temporary result frame to the original size by the first image scaling unit, and transmitting the image feature with the original size to the image blending unit; and
blending the image feature with the original size with the second frame to generate the video result by the image blending unit.

16. The video processing method according to claim 14, wherein the step (a) comprises:
changing a size of the first frame by a first image scaling unit of the video pipeline; and
selecting an image feature of the first frame as the temporary result frame from the first frame with the changed size by an image processing unit of the video pipeline; and
the step (c) comprises:
restoring the size of the temporary result frame to the original size by a second image scaling unit of the video pipeline, and transmitting the image feature with the original size to the image blending unit; and
blending the image feature with the original size with the second frame to generate the video result by the image blending unit.

17. The video processing method according to claim 10, further comprising:
storing the temporary result frame in a temporary memory.

18. The video processing method according to claim 10, further comprising:
storing the video result in a result memory.
